(19) United States
(12) Patent Application Publication
(10) Pub. No.: US 2007/0085830 A1
(43) Pub. Date: Apr. 19, 2007

(54) Pointer displaying apparatus, method, and medium

(75) Inventors: Ho-joon Yoo, Goyang-si (KR); Ki-wan Choi, Anyang-si (KR); Sun-gi Hong, Hwasung-si (KR); Yong-beom Lee, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/513,093

(22) Filed: Aug. 31, 2006

(30) Foreign Application Priority Data
Oct. 18, 2005 (KR) 10-2005-0098168

(51) Int. Cl. G09G 5/08

(52) U.S. Cl. 345/158

(57) ABSTRACT

A pointer displaying apparatus, method, and medium are provided. The pointer displaying apparatus includes a management unit which sets an event zone for an object currently being displayed on a screen, the object being referred to as the current object; a reception unit which receives the coordinates of a pointed-to-spot currently being pointed at by a direct pointing device; a control unit which determines whether the pointed-to-spot is included in the event zone; and a screen coordinate determination unit which determines screen coordinates of a location on the screen where a pointer is to be displayed based on the coordinates of the center of the current object and the coordinates of the pointed-to-spot.

### CROSS-REFERENCE TO RELATED APPLICATIONS

This application claims the benefit of Korean Patent Application No. 10-2005-0098168 filed on Oct. 18, 2005 in the Korean Intellectual Property Office, the disclosure of which is incorporated herein by reference in its entirety.

### BACKGROUND OF THE INVENTION

1. Field of the Invention

The present invention relates to a pointer displaying apparatus, method, and medium, and more particularly, to a pointer displaying apparatus, method, and medium which can allow a user to choose an object on a screen using a direct pointing device and can minimize the degree to which a pointer is shifted due to a shake in the user's hands when manipulating the direct pointing device.

2. Description of the Related Art

Direct pointing devices are input devices which can extract a screen zone of the display device, detect the location of a portion on the screen currently being pointed at by the pointer, and control the location of the pointer according to the results of the detection.

Direct pointing devices use a direct mapping method by which a pointer is located at a place pointed at by a user and thus can manipulate the location of a pointer more quickly and easily than pointing devices such as mouse or keypads which use a relative mapping method. Also, direct pointing devices can allow a user to control the location of a pointer from a distance.

However, if a user's hands shake when manipulating a direct pointing device to choose an object displayed on a screen, a pointer shakes on the screen, which makes it difficult for the user to choose an object displayed on the screen. In addition, direct pointing devices require a user to precisely point at a desired object on a screen with a pointer. However, if the size of the desired object on the screen is too small, the user is likely to have difficulty in manipulating a direct pointing device to choose the desired object on the screen.

### SUMMARY OF THE INVENTION

Additional aspects, features, and/or advantages of the invention will be set forth in part in the description which follows and, in part, will be apparent from the description, or may be learned by practice of the invention.

The present invention provides a pointer displaying apparatus, method, and medium, which can allow a user to choose an object on a screen using a direct pointing device and can minimize the degree to which the pointer is shifted due to a shake in the user's hands when manipulating the direct pointing device.

According to an aspect of the present invention, there is provided a pointer displaying apparatus including a management unit which sets an event zone for an object currently being displayed on a screen, the object being referred to as the current object; a reception unit which receives the coordinates of a pointed-to-spot currently being pointed at by a direct pointing device; a control unit which determines whether the pointed-to-spot is included in the event zone; and a screen coordinate determination unit which determines screen coordinates of a location on the screen where a pointer is to be displayed based on the coordinates of the center of the current object and the coordinates of the pointed-to-spot if the pointed-to-spot is included in the event zone.

According to another aspect of the present invention, there is provided a pointer displaying method including (a) setting an event zone for an object currently being displayed on a screen, the object being referred to as the current object; (b) receiving the coordinates of a pointed-to-spot currently being pointed at by a direct pointing device; (c) determining whether the pointed-to-spot is included in the event zone; and (d) determining screen coordinates of a location on the screen where a pointer is to be displayed based on the coordinates of the center of the current object and the coordinates of the pointed-to-spot if the pointed-to-spot is included in the event zone.

According to another aspect of the present invention, there is provided a pointer displaying apparatus including a management unit which sets an event zone for an object currently being displayed on a screen; a reception unit which receives coordinates of a pointed-to-spot currently being pointed at by a direct pointing device in the event zone; and a screen coordinate determination unit which determines screen coordinates of a location on the screen where a pointer is to be displayed based on the coordinates of the center of the object and the coordinates of the pointed-to-spot.

According to another aspect of the present invention, there is provided a pointer displaying method including setting an event zone for an object currently being displayed on a screen; receiving coordinates of a pointed-to-spot currently being pointed at by a direct pointing device in the event zone; and determining screen coordinates of a location on the screen where a pointer is to be displayed based on the coordinates of the center of the object and the coordinates of the pointed-to-spot.

According to another aspect of the present invention, there is provided a pointer displaying medium for all methods of the present invention.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a schematic diagram of a pointer displaying system according to an exemplary embodiment of the present invention;

FIG. 2 is a block diagram of a direct pointing device illustrated in FIG. 1;

FIGS. 3A through 3C are diagrams illustrating images input to the direct pointing device illustrated in FIG. 2;

FIG. 4 is a block diagram of a pointer displaying apparatus illustrated in FIG. 1;

FIGS. 5A through 5E are diagrams for explaining a method of setting an event zone for an object according to an exemplary embodiment of the present invention;

FIGS. 6A through 6C are diagrams for explaining a method of detecting the coordinates of a location on a screen according to an exemplary embodiment of the present invention;

FIG. 7 is a graph for explaining a method of determining the coordinates of a pointer displayed on a screen according to an exemplary embodiment of the present invention; and

FIG. 8 is a flowchart illustrating a pointer displaying method according to an exemplary embodiment of the present invention.

### DETAILED DESCRIPTION OF THE PREFERRED EMBODIMENTS

The present invention will now be described more fully with reference to the accompanying drawings, in which exemplary embodiments of the invention are shown. The invention may, however, be embodied in many different forms and should not be construed as being limited to exemplary embodiments set forth herein; rather, these exemplary embodiments are provided so that this disclosure will be thorough and complete, and will fully convey the concept of the invention to those skilled in the art. Like reference numerals in the drawings denote like elements, and thus their description will be omitted.

The term ‘unit’ used in this disclosure refers to a software program or a hardware device (such as a field programmable gate array (FPGA) or an application specific integrated circuit (ASIC)) which performs a predetermined function. However, the present invention is not restricted to this. In particular, modules may be implemented in a storage medium which can be addressed or may be configured to be able to execute one or more processors. Examples of the modules include software components, object-oriented software components, class components, task components, processes, functions, attributes, procedures, sub-routines, program code segments, drivers, firmware, microcode, circuits, data, databases, data architecture, tables, arrays, and variables. The functions provided by components or modules may be integrated with one another so that they can executed by a smaller number of components or modules or may be divided into smaller functions so that they need additional components or modules.

Exemplary embodiments of a pointer displaying apparatus, method, and medium will hereinafter be described in detail with reference to the accompanying drawings.

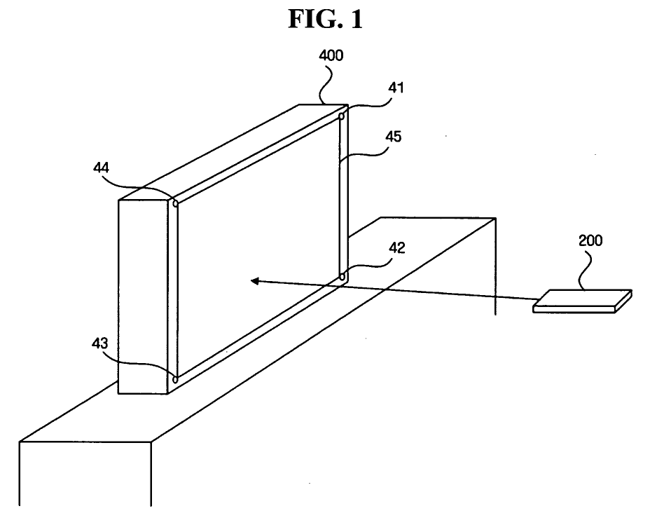

First, a pointer displaying apparatus according to an exemplary embodiment of the present invention will hereinafter be described in detail with reference to FIGS. 1 through 3C.

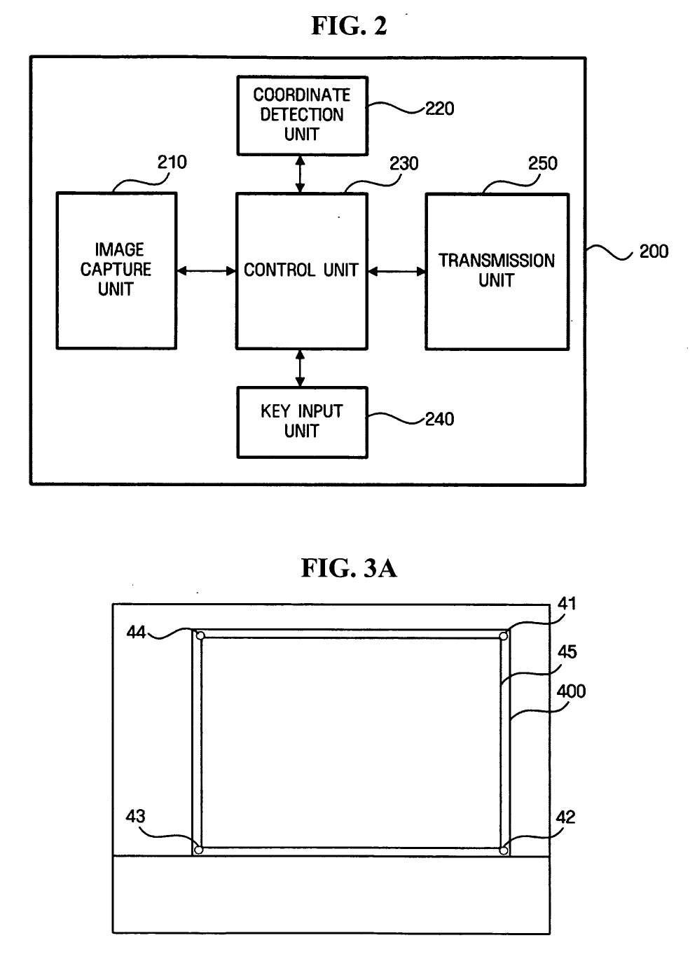

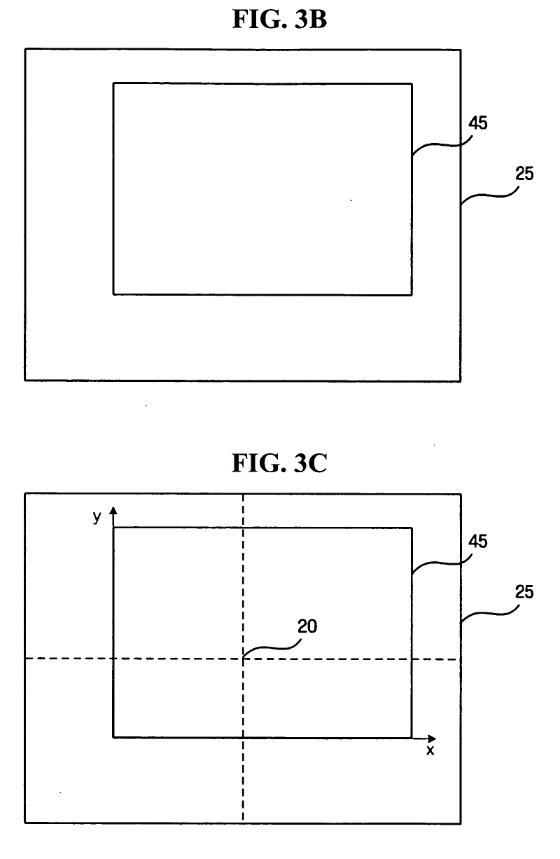

FIG. 1 is a schematic diagram of a pointer displaying system according to an exemplary embodiment of the present invention, FIG. 2 is a block diagram of a direct pointing device 200 illustrated in FIG. 1, and FIGS. 3A through 3C are block diagrams of a pointer displaying apparatus 400 illustrated in FIG. 1.

Referring to FIG. 1, the pointer displaying system includes the direct pointing device 200 and the pointer displaying apparatus 400.

The direct pointing device 200 provides a user command to the pointer displaying apparatus 400. Also, the direct pointing device 200 detects a screen zone 45 of the pointer displaying apparatus 400, and detects the coordinates of a location on the detected screen pointed at by a pointer. The structure and operation of the direct pointing device 200 will hereinafter be described in further detail with reference to FIG. 2.

FIG. 2 is a block diagram of the direct pointing device 200. Referring to FIG. 2, the direct pointing device 200 includes a key input unit 240, an image capture unit 210, a coordinate detection unit 220, a control unit 230, and a transmission unit 250.

The key input unit 240 includes a plurality of function keys which can control the operation of the pointer displaying apparatus 400. Examples of the function keys include a direction key (not shown), a select key (not shown), and a plurality of number keys (not shown). The function keys included in the key input unit 240 generate a key signal when user input is applied thereto. The key signal generated by the key input unit 240 is provided to the control unit 230.

The control unit 230 connects the key input unit 240, the image capture unit 210, the coordinate detection unit 220, and the transmission unit 250 to one another and controls the operations of the key input unit 240, the image capture unit 210, the coordinate detection unit 220, and the transmission unit 250 according to a user command. For example, the control unit 230 generates command code corresponding to the key signal provided by the key input unit 240, and provides the command code to the transmission unit 250.

The image capture unit 210 receives an image of an area pointed at by the direct pointing device 200. The image capture unit 210 may be an image sensor device such as a digital camera.

The coordinate detection unit 220 detects the screen zone 45 of the pointer displaying apparatus 400 in the received image. The coordinate detection unit 220 may use a variety of methods to detect the screen zone 45 of the pointer displaying apparatus 400 in the received image.

For example, the coordinate detection unit 220 may detect the screen zone 45 of the pointer displaying apparatus 400 in the received image using brightness differences in the corresponding image. For example, the screen zone 45 of the pointer displaying apparatus 400 is likely to be rendered brighter than the surroundings in the received image. Therefore, the coordinate detection unit 220 may detect the screen zone 45 of the pointer displaying apparatus 400 by detecting the edges of a zone rendered brighter than other zones in the received image.

Also, the coordinate detection unit 220 may detect the screen zone 45 of the pointer displaying apparatus 400 using a plurality of indicators (such as indicators 41, 42, 43 and 44), which can be easily detected by a camera. For example, a light emitting device such as an infrared light emitting diode (LED) is installed at every corner of the screen zone 45 of the pointer displaying apparatus 400. Then the coordinate detection unit 220 can detect the screen zone 45 of the pointer displaying apparatus 400 by detecting the locations of the light emitting devices in the received image. If the received image is as illustrated in FIG. 3A, the coordinate detection unit 220 may detect the screen zone 45 of the pointer displaying apparatus 400 in a manner illustrated in FIG. 3B.

Once the coordinate detection unit 220 detects the screen zone 45 of the pointer displaying apparatus 400, the coordinate detection unit 220 determines where in the detected screen zone 45 a spot (hereinafter referred to as the pointed-to-spot) currently being pointed at by a user with the direct pointing device 200 is located. In other words, the coordinate detection unit 220 determines the coordinates of the pointed-to-spot in the detected screen zone 45. The coordinate detection unit 220 may use a variety of methods to determine the coordinates of the pointed-to-spot.

For example, the coordinate detection unit 220 may determine the coordinates of the pointed-to-spot on the assumption that the pointed-to-spot is located at the center 20 of a received image 25. In this case, the coordinate detection unit 220 detects the center 20 of the received image 25, and determines the location of the center 20 of the received image relative to the detected screen zone 25, thereby determining the coordinates of the pointed-to-spot. The coordinate detection unit 220 transmits the coordinates of the pointed-to-spot to the transmission unit 250.

The transmission unit 250 modulates one of the command code provided by the control unit 230 and the coordinates of the pointed-to-spot provided by the coordinate detection unit 220 into a wireless signal, e.g., an infrared signal, and transmits the wireless signal to the pointer displaying apparatus 400.

The pointer displaying apparatus 400 sets a predetermined event zone for an object displayed in the screen zone 45 of the pointer displaying apparatus 400 so that the predetermined event zone can include the object. Thereafter, the pointer displaying apparatus 400 determines whether the pointed-to-spot is included in the predetermined event zone by referencing the coordinates of the pointed-to-spot, which are received from the direct pointing device 200. Thereafter, the pointer displaying apparatus 400 decides whether to determine the coordinates (hereinafter referred to as the screen coordinates) of a location on a screen where a pointer is to be displayed according to whether the pointed-to-spot is included in the predetermined event zone.

For example, if the pointed-to-spot is not included in the predetermined event zone, the pointer displaying apparatus 400 displays a pointer at the coordinates of the pointed-to-spot.

On the other hand, if the pointed-to-spot is included in the predetermined event zone, the pointer displaying apparatus 400 determines the screen coordinates based on the coordinates of the center of the object and the coordinates of the pointed-to-spot, and displays a pointer at the determined screen coordinates. Accordingly, even when the pointed-to-spot is distant apart from the center of the object, the pointer displaying apparatus 400 can display a pointer on the screen near the object, thereby allowing the user to easily choose the object.

In addition, when the pointed-to-spot is shifted from one point to another within the predetermined event zone, the pointer displaying apparatus 400 reduces further the amount by which the pointer is shifted as the distance between the pointed-to-spot and the center of the object decreases. Thus, the pointer displaying apparatus can minimize the degree by which a pointer is shifted due to a shake in the user's hands when manipulating the direct pointing device 200.

The pointer displaying apparatus 400 may be realized as a digital device. Here, the term ‘digital device’ refers to devices comprising digital circuits capable of processing digital data. Examples of the digital device include computers, printers, digital cameras, digital photocopiers, digital home appliances, digital telephones, digital projectors, home servers, digital video recorders, digital satellite broadcast receivers, set-top boxes, and digital TV broadcast receivers.

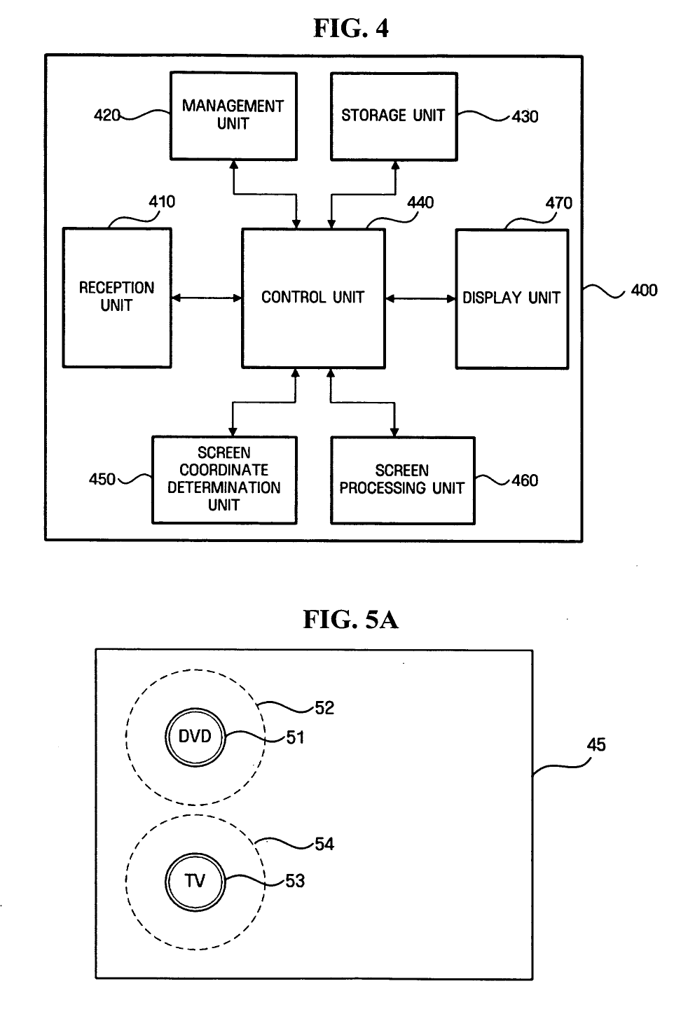

The structure and operation of the pointer displaying apparatus 400 will hereinafter be described in further detail with reference to FIG. 4.

FIG. 4 is a block diagram of the pointer displaying apparatus 400. Referring to FIG. 4, the pointer displaying apparatus 400 includes a reception unit 410, a management unit 420, a storage unit 430, a screen coordinate determination unit 450, a screen processing unit 460, a display unit 470, and a control unit 440.

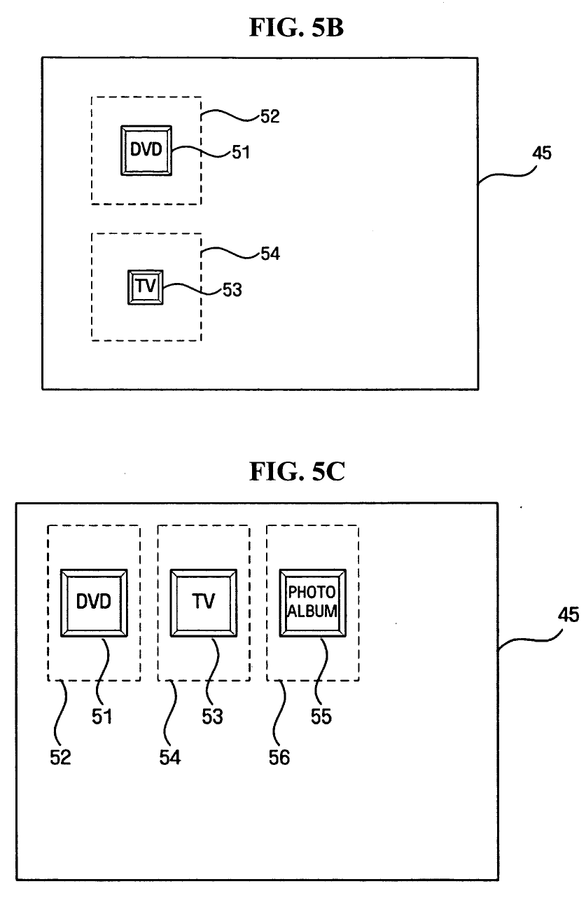

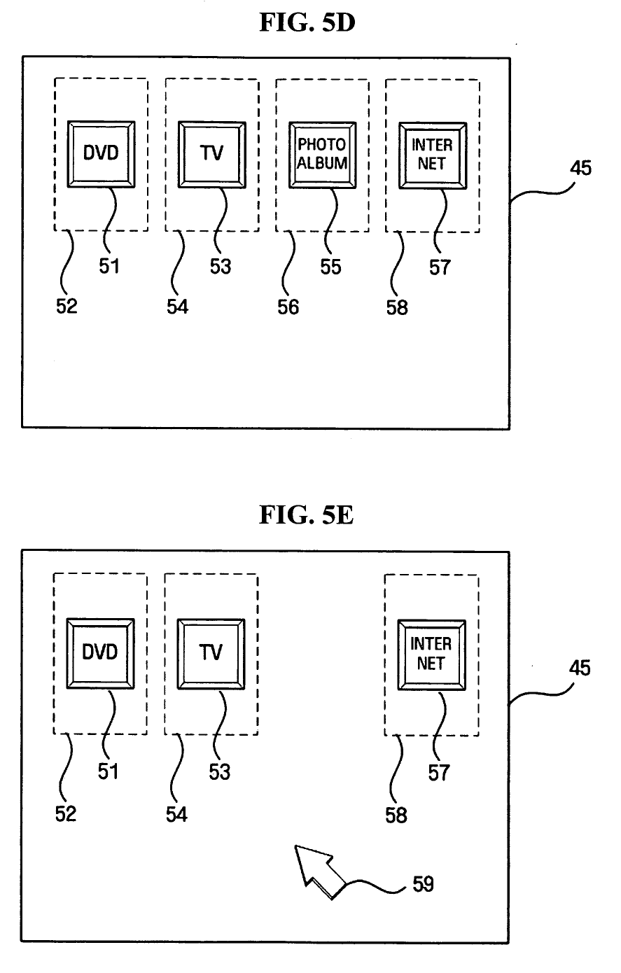

FIGS. 5A through 5E are diagrams for explaining a method of setting an event zone for an object according to an exemplary embodiment of the present invention. In FIGS. 5A through 5E, an object ‘DVD’ (51), an event zone (52), an object ‘TV’ (53), an event zone (54), an object ‘Photo Album’ (55), an event zone (56), an object ‘Internet’ (57), an event zone (58), and a pointer (59) are shown on screen zone 45.

The management unit 420 sets an event zone for an object (hereinafter referred to as the current object) currently being displayed on a screen so that the event zone can include the current object. The shape of the event zone for the current object may be determined according to the shape of the current object. For example, if the current object is circular, the management unit 420 may set a circular event zone for the current object, as illustrated in FIG. 5A. Alternatively, if the current object is rectangular, the management unit 420 may set a rectangular event zone for the current object, as illustrated in FIG. 5B.

In addition, the management unit 420 may adaptively set an event zone for the current object according to the size of the current object and the location of the current object relative to other objects on the screen. For example, if a plurality of objects having different sizes are displayed in the screen zone of the pointer displaying apparatus 400, the management unit 420 may set an event zone for each of the objects in such a manner that the event zone for a large object is narrower than the event zone for a small object, as illustrated in FIG. 5B. If a plurality of objects are arranged in the screen zone of the pointer displaying apparatus 400 and are adjacent to one another, the management unit 420 may set an event zone for each of the objects in a manner illustrated in FIG. 5C.

The management unit 420 manages information regarding one or more objects displayed in the screen zone of the pointer displaying apparatus 400, for example, information regarding the sizes and central coordinates of the objects and information regarding a plurality of event zones respectively set for the objects. For example, if a new object is added to the screen zone of the pointer displaying apparatus 400, the management unit 420 sets an event zone for the new object according to the location of the new object relative to other existing objects displayed in the screen zone of the pointer displaying apparatus, and stores information regarding the new object, e.g., information regarding the size and central coordinates of the new object and information regarding the event zone set for the new object, in the storage unit 430. If one of the existing objects is deleted from the screen zone of the pointer displaying apparatus 400, the management unit 420 deletes information regarding the deleted object, e.g., information regarding the central coordinates and size of the deleted object and information regarding an event zone set for the deleted object, from the storage unit 430.

The management unit 420 may classify a plurality of objects displayed on the screen into one or more groups, and manage information regarding the objects in units of the groups. For example, referring to a screen image illustrated in FIG. 5C, the management unit 420 may classify an object ‘DVD’ (51), an object ‘TV’ (53), and an object ‘Photo Album’ (55) into a first group and manage information regarding the object ‘DVD’ (51), the object ‘TV’ (53), and the object ‘Photo Album’ (55) together. Referring to FIG. 5D, if an object ‘Internet’ (57) is newly added to the screen image illustrated in FIG. 5C, the management unit 420 may add the object ‘Internet’ (57) to the first group so that information regarding the object ‘Internet’ (57) can be managed together with the information regarding the object ‘DVD’ (51), the object ‘TV’ (53), and the object ‘Photo Album’ (55). Referring to FIG. 5E, if the object ‘Photo Album’ (55) is deleted from the screen image illustrated in FIG. 5C, the management unit 420 may delete the object ‘Photo Album’ (55) from the first group.

The storage unit 430 stores algorithms needed to determine screen coordinates. Also, the storage unit 430 stores information on a plurality of graphic components and a plurality of objects displayed in the screen zone of the pointer displaying apparatus 400, e.g., information regarding the sizes and central coordinates of the objects and information regarding a plurality of event zones respectively set for the objects. A plurality of objects may be classified into one or more groups, and information regarding the objects may be stored in the storage unit 430 in units of the groups as a table. The storage unit 430 may be a non-volatile memory device such as a read only memory (ROM), a programmable ROM (PROM), an erasable PROM (EPROM), an electrically erasable PROM (EEPROM), or a flash memory, a volatile memory device such as a random access memory (RAM), or a storage medium such as a hard disc drive. However, the present invention is not restricted to this list of memories and other types of storage units may be used.

The reception unit 410 receives a remote control signal and the coordinates of a pointed-to-spot from the direct pointing device 200. The reception unit 410 provides the remote control signal and the coordinates of the pointed-to-spot to the control unit 440.

The control unit 440 connects the reception unit 410, the management unit 420, the storage unit 430, the screen coordinate determination unit 450, the screen processing unit 460, and the display unit 470 to one another and controls the operations of the reception unit 410, the management unit 420, the storage unit 430, the screen coordinate determination unit 450, the screen processing unit 460, and the display unit 470. For example, referring to FIG. 5E, if a pointer 59 is superimposed on the object ‘Internet’ (57), the control unit 440 controls the image processing unit 460 to generate a screen image for providing an Internet service.

Referring to FIG. 4, the control unit 440 searches through the storage unit 430 and determines whether the pointed-to-spot is within the event zone for the current object. If the results of the determination indicate that the pointed-to-spot is not within the event zone for the current object, the control unit 440 provides the coordinates of the pointed-to-spot to the screen processing unit 460, and controls the screen processing unit 460 to display a pointer at the coordinates of the pointed-to-spot. On the other hand, if the results of the determination indicate that the pointed-to-spot is within the event zone for the current object, the control unit 440 controls the screen coordinate determination unit 450 to determine screen coordinates according to the pointed-to-spot.

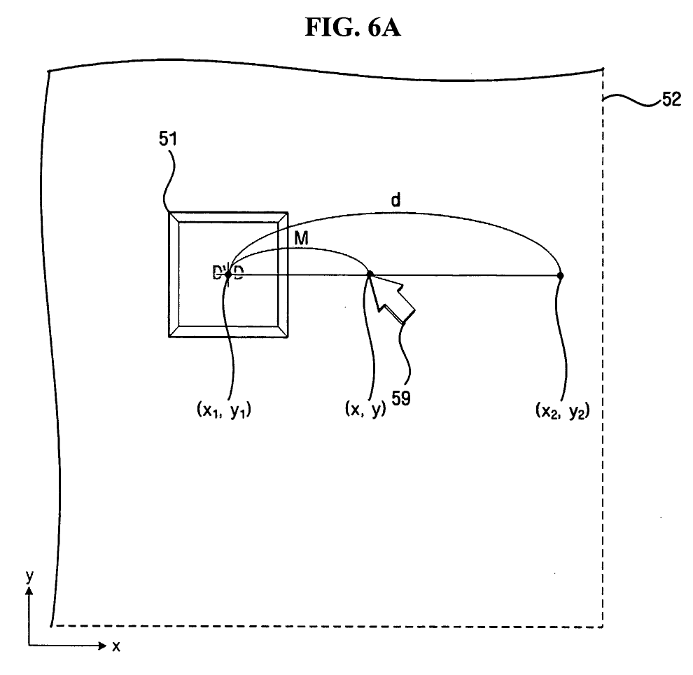

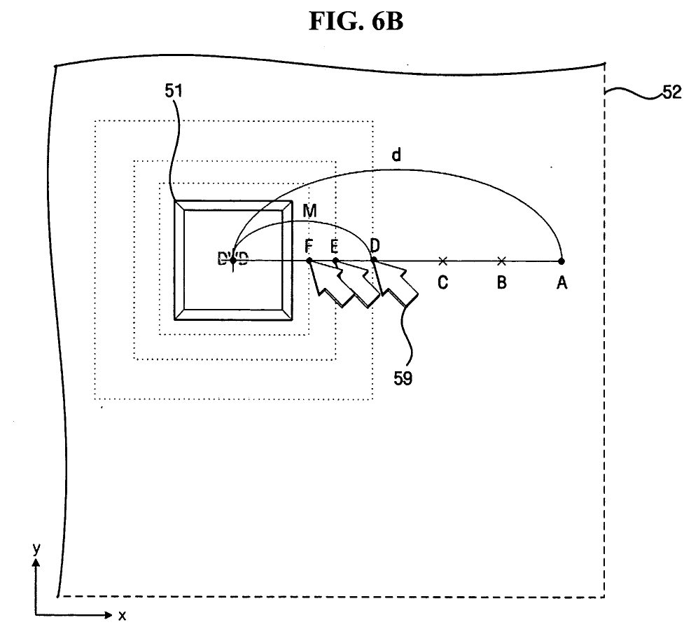

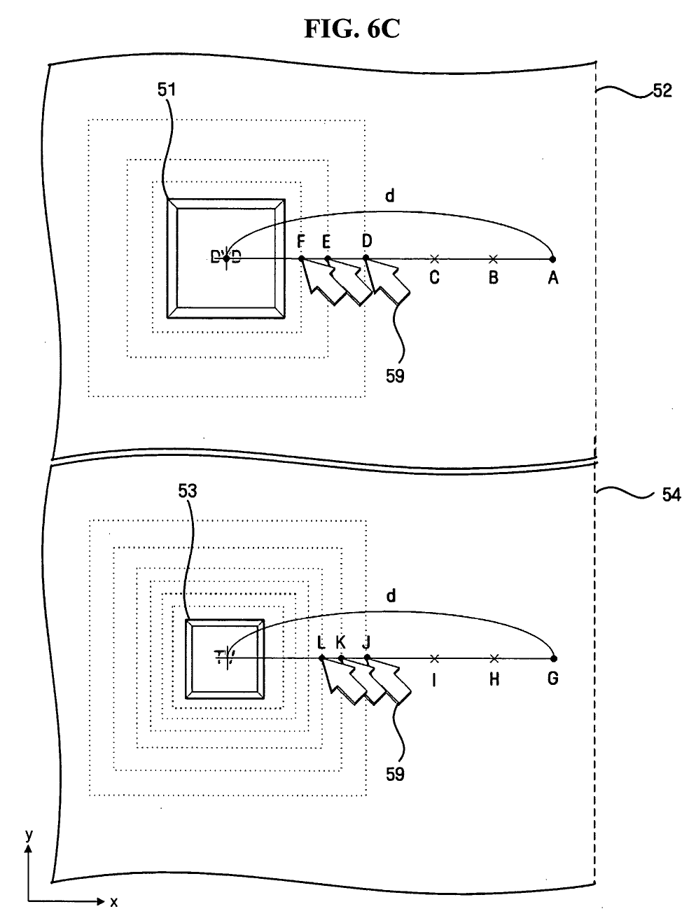

For example, if the pointed-to-spot is within the event zone for the current object, the screen coordinate determination unit 450 determines screen coordinates, i.e., determines where a pointer is to be displayed, with reference to the central coordinates of the current object and the coordinates of the pointed-to-spot. The screen coordinate determination unit 450 may determine the screen coordinates according to an algorithm stored in the storage unit 430. Thereafter, the screen coordinate determination unit 450 provides the screen coordinates to the screen processing unit 460. The determination of the screen coordinates by the screen coordinate determination unit 450 will be described later in further detail with reference to FIGS. 6A through 6C.

The screen processing unit 460 displays a pointer either at the screen coordinates, which are provided by the screen coordinate determination unit 450, or at the coordinates of the pointed-to-spot, which are received from the direct pointing device 200. For example, if the pointed-to-spot is not included in any of a plurality of event zones respectively set for a plurality of objects displayed in the screen zone of the pointer displaying apparatus 400, the screen processing unit 460 may display a pointer at the coordinates of the pointed-to-spot, as illustrated in FIG. 5E. However, if the pointed-to-spot is included in one of the event zones respectively set for the objects displayed in the screen zone of the pointer displaying apparatus 400, the screen processing unit 460 may display the pointer at the screen coordinates.

The display unit 470 visualizes the result of the displaying performed by the screen processing unit 460. The display unit 470 may be realized as a flat panel display device such as a liquid crystal display (LCD) device.

A method of determining screen coordinates according to an exemplary embodiment of the present invention will hereinafter be described in detail with reference to FIGS. 6A through 6C.

FIGS. 6A and 6B are expanded views illustrating the object ‘DVD’ (51) illustrated in FIG. 5B and an event zone 52 set for the object ‘DVD’ (51), and FIG. 6C is an expanded view illustrating the object ‘DVD’ (51) and the object ‘TV’ (53) illustrated in FIG. 5B, the event zone 52 set for the object ‘DVD’ (51), and an event zone 54 set for the object ‘TV’ (53).

Referring to FIG. 6A, assume that the coordinates of a center of the object ‘DVD’ (51) are (x₁, y₁) and the coordinates of a pointed-to-spot are (x₂, Y₂). If the pointed-to-spot is within the event zone 52, a point represented by screen coordinates may be located on a line drawn between the center of the object ‘DVD’ (51) and the pointed-to-spot.

If the distance between the center of the object ‘DVD’ (51) and the pointed-to-spot is d and the distance between the center of the object ‘DVD’ (51) and the point represented by the screen coordinates (x, y) is M, then the point represented by the screen coordinates (x, y) is an internal division point which divides a line drawn between the center of the object ‘DVD’ (51) and the pointed-to-spot at a ratio of M:(d-M).

Therefore, the screen coordinates (x, y) may be indicated by Equation (1):

$$x = {x}_{1} + M \frac{( {x}_{2} - {x}_{1} )}{d} \\ y = {y}_{1} + M \frac{( {y}_{2} - {y}_{1} )}{d} \qquad ( 1 )$$

According to Pythagoras' Theorem, the distance d between the center of the object ‘DVD’ (51) and the pointed-to-spot may be indicated by Equation (2):
d=√(x₂₋x₁)²+(y₂y₁) (2)

Since the point represented by the screen coordinates (x, y) is an internal division point which divides the line between the center of the object ‘DVD’ (51) and the pointed-to-spot at a ratio of M:(d-M), the distance M between the center of the object ‘DVD’ (51) and the point represented by the screen coordinates (x, y) satisfies Equation (3):
0≦M≦d (3)

The distance M between the center of the object ‘DVD’ (51) and the point represented by the screen coordinates (x, y) may also be indicated by Equation (4):
M=ρ·d
0≦ρ≦1 (4)
where ρ is an increasing function within the range from 0 to 1.

According to the present exemplary embodiment, as the distance d between the center of the object ‘DVD’ (51) and the pointed-to-spot decreases, the amount by which a pointer is shifted must be reduced accordingly. The amount by which a pointer is shifted is determined according to M. Thus, in order for M to satisfy Equation (4) above, ρ can be a fractional function defined by Equation (5):

$$ρ = \frac{1}{{( \frac{c}{d} )}^{n} + 1} \qquad ( 5 )$$

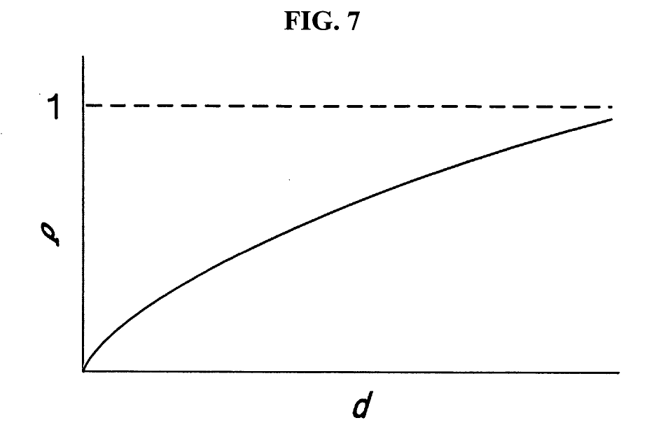

FIG. 7 is a graph illustrating the relationship between ρ and d.

By using Equation (5), Equation (4) may be rearranged into Equation (6):

$$M = \frac{{d}^{n}}{{c}^{n} + {d}^{n}} d \qquad ( 6 )$$

If M is defined by Equation (6), the trajectory of a pointer as a pointed-to-spot within an event zone for an object is shifted toward the center of the object is illustrated in FIG. 6B. Referring to FIG. 6B, when a pointed-to-spot is shifted from point A to point B and from point B to point C, the pointer (59) is respectively shifted from point D to point E and from point E to point F. Even though the distance between point A and point B is the same as the distance between point B to point C, the amount by which the pointer (59) is shifted when the pointed-to-spot is shifted from point A to point B is larger than the amount by which the pointer (59) is shifted when the pointed-to-spot is shifted from point B to point C. In other words, even when the pointed-to-spot is shifted often from one point to another within a predetermined event zone, it is possible to reduce the amount by which the pointer (59) is shifted.

When a plurality of objects having different sizes are displayed on the same screen, it is more difficult for a user to choose a small object than to choose a large object. Given all this, the amount by which a pointer is shifted when a pointed-to-spot is shifted from one point to another must be more reduced for small objects than for large objects. In order to meet this requirement, the value of a variable c in Equation (6) may be an arbitrary positive real value which is inversely proportional to the size of an object, and the value of a variable n in Equation (6) may be an arbitrary positive integer value which is proportional to the size of an object. For example, the variables c and n. may be defined by Equation (7):
c=500−Object Size
n=0.02×Object Size (7)

According to Equation (7), the smaller the distance between the center of an object and a pointed-to-spot is, the less the amount by which a pointer is shifted becomes, and the smaller the size of an object is, the less the amount by which a pointer is shifted becomes.

For example, referring to the event zone (52) illustrated in FIG. 6C, when a pointed-to-spot, which is a predetermined distance, i.e., d, distant apart from the center of the object ‘DVD’ (51), is shifted from point A to point B, the pointer (59) is shifted from point D to point E. On the other hand, referring to the event zone 54 illustrated in FIG. 6C, when a pointed-to-spot, which is d distant apart from the center of the object ‘TV’ (53), is shifted from point G to point H, the pointer 59 is shifted from point J to point K.

The values of the variables c and n defined by Equation (7) may be stored in the storage unit 430 as information regarding a corresponding object, and the stored values may be altered or deleted by the management unit 420. For example, the size of an object displayed on a screen may be altered according to the screen resolution. Thus, when the screen resolution is altered, the management unit 420 may alter the values of the variables c and n stored in the storage unit 430 accordingly.

‘Object Size’ in Equation (7) may indicate the length or area of an object. For example, ‘Object Size’ may indicate the length or area of a rectangular object. Alternatively, ‘Object Size’ may indicate the radius or diameter of a circular object.

Referring back to FIG. 4, the screen coordinate determination unit 450 determines the distance between the center of the current object and the pointed-to-spot using Equation (2), and determines screen coordinates using Equations (1) and (6). The screen coordinate determination unit 450 may search through the storage unit 430 to detect the values of the variables c and n for the current object.

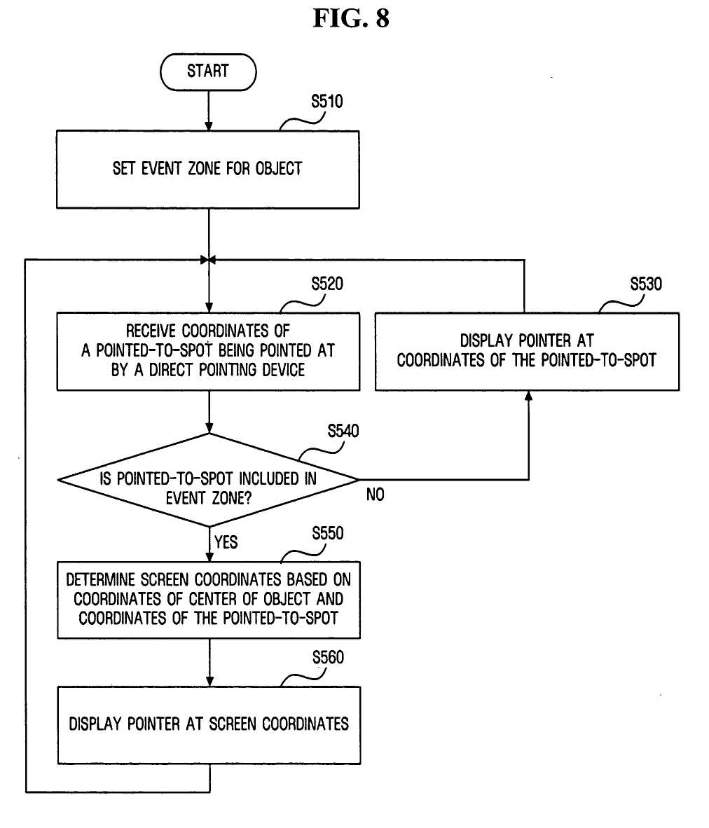

A pointer displaying method according to an exemplary embodiment of the present invention will hereinafter be described in detail with reference to FIG. 8.

FIG. 8 is a flowchart illustrating a pointer displaying method according to an exemplary embodiment of the present invention, i.e., the operation of the pointer displaying apparatus 400 illustrated in FIG. 4. Referring to FIG. 8, the image capture unit 210 of the direct pointing device 200 receives an image of an area pointed at by the direct pointing device 200. An example of the received image is illustrated in FIG. 3A.

Thereafter, the coordinate detection unit 220 of the direct pointing device 200 detects a screen zone 45 of the pointer displaying apparatus 400 in the received image 25. For example, if the pointer displaying apparatus 400 comprises a plurality of indicators 41, 42, 43, and 44 such as light emitting devices (e.g., infrared LEDs) which are respectively located at the corners of the screen zone 45 of the pointer displaying apparatus 400, the coordinate detection unit 220 may detect the screen zone 45 of the pointer displaying apparatus 400, as illustrated in FIG. 3B, by detecting a zone rendered brighter than other zones in the received image 25.

Thereafter, the coordinate detection unit 220 of the direct pointing device 200 determines where in the detected screen zone 45 a pointed-to-spot is located. For this, the coordinate detection unit 220 detects the center of the received image 25. Thereafter, the coordinate detection unit 220 determines the coordinates of the pointed-to-spot by determining the location of the center of the received image 25 relative to the detected screen zone 45.

Once the coordinates of the pointed-to-spot are determined, the transmission unit 250 of the direct pointing device 200 transmits the coordinates of the pointed-to-spot to the pointer displaying apparatus 400.

Referring to FIG. 8, in operation S510, the pointer displaying apparatus 400 sets an event zone for an object (hereinafter referred to as the current object) currently being displayed on a screen so that the event zone can include the current object, and stores information regarding the event zone in the storage unit 430.

In operation S520, the reception unit 410 of the pointer displaying apparatus 400 receives the coordinates of the pointed-to-spot from the direct pointing device 200. In operation S540, the control unit 440 of the pointer displaying apparatus 400 searches through the storage unit 430 to determine whether the pointed-to-spot is included in the event zone for the current object.

If it is determined in operation S540 that the pointed-to-spot is not included in the event zone for the current object, the control unit 440 of the pointer displaying apparatus 400 provides the coordinates of the pointed-to-spot to the screen processing unit 460, and the method proceeds to operation S530. In operation S530, the screen processing unit 460 displays a pointer at the coordinates of the pointed-to-spot, and the display unit 470 visualizes the result of the displaying performed by the screen processing unit 460.

On the other hand, if it is determined in operation S540 that the pointed-to-spot is included in the event zone for the current object, the control unit 440 provides the screen coordinate determination unit 450 with information regarding the current object and the coordinates of the pointed-to-spot, e.g., information regarding the object ‘DVD’ (51) illustrated in FIG. 6A and the coordinates of the pointed-to-spot, and the method proceeds to operation S550.

In operation S550, the screen coordinate determination unit 450 determines screen coordinates based on the coordinates of the center of the current object, which are stored in the storage unit 430, and the coordinates of the pointed-to-spot. For example, referring to FIG. 6B, if the pointed-to-spot is located at point A, the screen coordinate determination unit 450 determines screen coordinates, i.e., the coordinates of point D, based on the coordinates of the center of the object ‘DVD’ (51) and the coordinates of point A. In operation S550, the screen coordinate determination unit 450 may use an algorithm stored in advance in the storage unit 430 to determine the screen coordinates. For example, the screen coordinate determination unit 450 may use Equations (1) and (6) to determine the screen coordinates. Once the screen coordinates are determined, the screen coordinate determination unit 450 provides the screen coordinates to the screen processing unit 460.

In operation S560, the screen processing unit 460 displays a pointer at the screen coordinates provided by the screen coordinate determination unit 450, and the display unit 470 visualizes the result of the displaying performed by the screen processing unit 460. For example, referring to FIG. 6B, the screen processing unit 460 may display the pointer at point D near the object ‘DVD’ (51). In this manner, the pointer displaying apparatus 400 can display the pointer near the current object even when the pointed-to-spot is distant apart from the current object, thereby allowing a user to easily choose the current object using the direct pointing device 200.

If a pointer is displayed near the object ‘DVD’ (51), as illustrated in FIG. 6A, the user may manipulate the direct pointing device 200 again to superimpose the pointer on the object ‘DVD’ (51). For this, the pointer displaying apparatus 400 may repeatedly perform operations S520 through S560.

In this case, as the distance between the object ‘DVD’ (51) and the pointed-to-spot decreases, the pointer displaying apparatus 400 reduces further the amount by which a pointer is shifted, thereby minimizing the degree to which the pointer is shifted due to a shake in the user's hands when manipulating the direct pointing device 200.

For example, if the pointed-to-spot is shifted from point A to point B and from point B and point C, as illustrated in FIG. 6B, the pointer displaying apparatus 400 respectively shifts the pointer 59 from point D to point E and from point E to point F.

Thereafter, the control unit 440 determines whether a point represented by the screen coordinates is superimposed on the object ‘DVD’ (51), and controls the operation of the pointer displaying apparatus 400 according to the results of the determination. For example, if the point represented by the screen coordinates is not superimposed on the object ‘DVD’ (51), the control unit 440 controls the pointer displaying apparatus 400 to perform operations S510 through S560. However, if the point represented by the screen coordinates is superimposed on the object ‘DVD’ (51), the control unit 440 executes a program which is linked to the object ‘DVD’ (51).

According to the present exemplary embodiment, the coordinates of the pointed-to-spot are determined by the direct pointing device 200. However, the present invention is not restricted to this. In other words, the coordinates of the pointed-to-spot may be determined by the pointer displaying apparatus 400.

For example, if the display unit 470 of the pointer displaying apparatus 400 is realized as a display device capable of sensing light and the direct pointing device 200 is designed to further include a predetermined light emission unit, the pointer displaying apparatus 400 can determine the coordinates of the pointed-to-spot.

In addition to the above-described exemplary embodiments, exemplary embodiments of the present invention can also be implemented by executing computer readable code/instructions in/on a medium/media, e.g., a computer readable medium/media. The medium/media can correspond to any medium/media permitting the storing and/or transmission of the computer readable code/instructions. The medium/media may also include, alone or in combination with the computer readable code/instructions, data files, data structures, and the like. Examples of code/instructions include both machine code, such as produced by a compiler, and files containing higher level code that may be executed by a computing device and the like using an interpreter.

The computer readable code/instructions can be recorded/transferred in/on a medium/media in a variety of ways, with examples of the medium/media including magnetic storage media (e.g., floppy disks, hard disks, magnetic tapes, etc.), optical media (e.g., CD-ROMs, or DVDs), magneto-optical media (e.g., floptical disks), hardware storage devices (e.g., read only memory media, random access memory media, flash memories, etc.) and storage/transmission media such as carrier waves transmitting signals, which may include computer readable code/instructions, data files, data structures, etc. Examples of storage/transmission media may include wired and/or wireless transmission media. For example, wired storage/transmission media may include optical wires/lines, waveguides, and metallic wires/lines, etc. including a carrier wave transmitting signals specifying instructions, data structures, data files, etc. The medium/media may also be a distributed network, so that the computer readable code/instructions is stored/transferred and executed in a distributed fashion. The medium/media may also be the Internet. The computer readable code/instructions may be executed by one or more processors. In addition, the above hardware devices may be configured to act as one or more software modules in order to perform the operations of the above-described exemplary embodiments.

As described above, the pointer displaying apparatus, method, and medium according to the present invention provides the following advantages.

First, even when a pointed-to-spot is distant apart from an object, the pointer displaying apparatus, method, and medium according to the present invention can display a pointer near the object, thereby allowing a user to easily choose the object using a direct pointing device.

Second, according to the present invention, as the distance between the center of the object and the pointed-to-spot decreases, the pointer displaying apparatus, method, and medium reduce further the amount by which the pointer is shifted. Accordingly, it is possible to minimize the degree to which the pointer is shifted due to a shake in the user's hands when manipulating the direct pointing device.

Third and finally, the pointer displaying apparatus, method, and medium according to the present invention use a direct mapping method and can thus allow the pointer to easily escape from any event zone with only a slight displacement of the pointed-to-spot.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. A pointer displaying apparatus comprising:
a management unit which sets an event zone for an object currently being displayed on a screen, the object being referred to as the current object;
a reception unit which receives the coordinates of a pointed-to-spot currently being pointed at by a direct pointing device;
a control unit which determines whether the pointed-to-spot is included in the event zone; and
a screen coordinate determination unit which determines screen coordinates of a location on the screen where a pointer is to be displayed based on the coordinates of the center of the current object and the coordinates of the pointed-to-spot if the pointed-to-spot is included in the event zone.

2. The pointer displaying apparatus of claim 1, wherein the management unit adaptively sets the event zone for the current object according to the size of the current object and the location of the current object relative to other objects on the screen.

3. The pointer displaying apparatus of claim 1, wherein the management unit classifies a plurality of objects displayed on the same screen into one or more groups and modifies, adds, or deletes information regarding the plurality of objects in units of the groups.

4. The pointer displaying apparatus of claim 1, wherein a point represented by the screen coordinates is located on a line drawn between the center of the current object and the pointing location.

5. The pointer displaying apparatus of claim 1, wherein, as the distance between the center of the current object and the pointed-to-spot decreases, the screen coordinate determination unit reduces further the amount by which the pointer is shifted.

6. The pointer displaying apparatus of claim 5, wherein, as the size of the current object decreases, the screen coordinate determination unit reduces further the amount by which the pointer is shifted.

7. The pointer displaying apparatus of claim 1 further comprising:
a screen processing unit which displays the pointer at the screen coordinates; and
a display unit which visualizes the result of the displaying performed by the screen processing unit.

8. The pointer displaying apparatus of claim 7, wherein the display unit is a flat panel display device.

9. The pointer displaying apparatus of claim 1, wherein the control unit chooses the current object according to whether the point represented by the screen coordinates is superimposed on the current object.

10. A pointer displaying method comprising:
(a) setting an event zone for an object currently being displayed on a screen, the object being referred to as the current object;
(b) receiving the coordinates of a pointed-to-spot currently being pointed at by a direct pointing device;
(c) determining whether the pointed-to-spot is included in the event zone; and
(d) determining screen coordinates of a location on the screen where a pointer is to be displayed based on the coordinates of the center of the current object and the coordinates of the pointed-to-spot if the pointed-to-spot is included in the event zone.

11. The pointer displaying method of claim 10, wherein (a) comprises adaptively setting the event zone for the current object according to the size of the current object and the location of the current object relative to other objects on the screen.

12. The pointer displaying method of claim 10, further comprises displaying the pointer at the coordinates of the pointed-to-spot if the pointed-to-spot is not included in the event zone based on the determination performed in (c).

13. The pointer displaying method of claim 10, wherein (d) comprises reducing further the amount by which the pointer is shifted as the distance between the center of the current object and the pointed-to-spot decreases.

14. The pointer displaying method of claim 13, wherein (d) further comprises reducing further the amount by which the pointer is shifted as the size of the current object decreases.

15. The pointer displaying method of claim 10, wherein (d) comprises:
displaying the pointer at the screen coordinates; and
visualizing the result of the displaying.

16. At least one medium comprising computer readable instructions implementing the method of claim 10.

17. The pointer displaying apparatus of claim 7, wherein if the control unit determines that the pointed-to-spot is not within the event zone, then the control unit provides coordinates of the pointed-to-spot to the screen processing unit to display a pointer at the coordinates of the pointed-to-spot, wherein the display unit visualizes the pointer of the displaying performed by the screen processing unit.

18. A pointer displaying apparatus comprising:
a management unit which sets an event zone for an object currently being displayed on a screen;
a reception unit which receives coordinates of a pointed-to-spot currently being pointed at by a direct pointing device in the event zone; and
a screen coordinate determination unit which determines screen coordinates of a location on the screen where a pointer is to be displayed based on the coordinates of the center of the object and the coordinates of the pointed-to-spot.

19. A pointer displaying method comprising:
setting an event zone for an object currently being displayed on a screen;
receiving coordinates of a pointed-to-spot currently being pointed at by a direct pointing device in the event zone; and
determining screen coordinates of a location on the screen where a pointer is to be displayed based on the coordinates of the center of the object and the coordinates of the pointed-to-spot.

20. At least one medium comprising computer readable instructions implementing the method of claim 19.
